(19) United States
(12) Patent Application Publication
(10) Pub. No.: US 2006/0264554 A1
(43) Pub. Date: Nov. 23, 2006

(54) Fiber reinforced polypropylene composite door core modules

(76) Inventors: Arnold Lustiger, Edison, NJ (US); Jeffrey Valentage, Royal Oak, MI (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/387,190

(22) Filed: Mar. 23, 2006

Related U.S. Application Data
(63) Continuation-in-part of application No. 11/318,363, filed on Dec. 23, 2005.
Application No. 11/318,363 is a continuation-in-part of application No. 11/301,533, filed on Dec. 13, 2005.
(60) Provisional application No. 60/681,609, filed on May 17, 2005.

(51) Int. Cl. C08K 3/34

(52) U.S. Cl. 524/451; 524/456

(57) ABSTRACT

A fiber reinforced polypropylene composite door core module. The door core module includes a module plate molded from a composition comprising at least 30 wt % polypropylene based resin, from 10 to 60 wt % organic fiber, from 0 to 40 wt % inorganic filler, and optionally lubricant (typically present at from 0 to 0.1 wt %), based on the total weight of the composition, the module plate having at least a first side and a second side. A process for producing a door core module is also provided. The process includes the step of injection molding a composition to form the door core module, the door core module having a module plate having at least a first side and a second side, wherein the composition comprises at least 30 wt % polypropylene, from 10 to 60 wt % organic fiber, from 0 to 40 wt % inorganic filler, and from 0 to 0.1 wt % lubricant, based on the total weight of the composition.

### CROSS-REFERENCE TO RELATED APPLICATIONS

This application is a Continuation-in-Part of U.S. patent application Ser. No. 11/318,363, filed Dec. 23, 2005, which is a Continuation-in-Part of U.S. patent application Ser. No. 11/301,533, filed Dec. 13, 2005, filed Dec. 13, 2005, and claims priority to U.S. Provisional Application Ser. No. 60/681,609 filed May 17, 2005.

### FIELD OF THE INVENTION

The present invention is directed generally to door core modules and the like produced from fiber reinforced polypropylene compositions and to processes for making such door core modules.

### BACKGROUND OF THE INVENTION

In recent years, efforts have been made to improve the quality of vehicle construction and reduce the cost of manufacturing and operating the vehicle. These efforts have focused on included reducing vehicle weight and fuel consumption. In the past, it was conventional for vehicle doors to include an outer body shell, an inner shell welded to the outer body shell, and an interior door trim panel mounted on the inner shell. The inner shell and the interior door trim panel formed the interior door wall. The inner shell was provided with built-in apertures for the introduction of the window winding mechanism into the inner cavity between the outer body shell and the inner shell.

The window winding mechanism was typically preassembled on a base plate, which was then disposed in the inner cavity of the door on the inner shell. Thus, installation of the window winding mechanism in the door wells formed by the welded sheets of the outer and inner shells was carried out on the vehicle on the main assembly line. The installation and adjustment of the window winding mechanism through the relatively small built-in aperture was however time-consuming, so that a correspondingly long period was needed for this assembly step and, thus, a correspondingly slower working speed for the main assembly line. As may be appreciated, the installation of the window winding mechanism in this manner, as well as its subsequent adjustment, was labor intensive, and could only be done by relatively skilled personnel.

In recent years in order to facilitate assembly and control the quality of vehicle door mechanisms, doors have been manufactured utilizing an outer body shell and door frame, without the control mechanism. Separately installed is a module plate with the window lift mechanism, the door latching mechanism and the like mounted thereto. This module plate is subsequently inserted into the door and secured, with a trim panel employed to cover the interior surface of the resultant door assembly. Although this construction allows better control of the quality of the mechanism mounted on a separate module plate, the resultant structure is still relatively heavy and requires assembly of the module plate to the vehicle door during manufacture as well as subsequent assembly of the trim panel to the door.

Yet another approach has been suggested in which a relatively rigid trim panel is employed that includes sufficient reinforcement so that the window lift mechanism, door latching mechanism and the like can be mounted directly to the trim panel, which is finished as a subassembly and attached directly to the outer door member. This construction, thus, provides a two-piece door construction in which the inner trim panel and associated operating hardware, including the window and its control mechanism, the door latch and the like, can be made as a single module and subsequently attached to the door during manufacture. Although this construction may provide for the quality control of the various components of the door assembly and reduces the overall cost, the weight, although reduced from prior constructions requiring carrier plates, is still somewhat heavy.

In the molding of automobile parts, injection molding and injection/compression molding processes have been employed using a variety of materials. Attempts are underway in the automotive industry to produce an ever larger number of molded plastic parts. As is widely appreciated, plastic parts have the advantage of light weight, corrosion resistance and lower cost.

Polyolefins have limited use in engineering applications due to the tradeoff between toughness and stiffness. For example, polyethylene is widely regarded as being relatively tough, but low in stiffness. Polypropylene generally displays the opposite trend, i.e., is relatively stiff, but low in toughness.

Several well known polypropylene compositions have been introduced which address toughness. For example, it is known to increase the toughness of polypropylene by adding rubber particles, either in-reactor resulting in impact copolymers, or through post-reactor blending. However, while toughness is improved, the stiffness is considerably reduced using this approach.

Glass reinforced polypropylene compositions have been introduced to improve stiffness. However, the glass fibers have a tendency to break in typical injection molding equipment, resulting in reduced toughness and stiffness. In addition, glass reinforced products have a tendency to warp after injection molding

Another known method of improving physical properties of polyolefins is organic fiber reinforcement. For example, in EP Patent Application 0397881, proposes a composition produced by melt-mixing 100 parts by weight of a polypropylene resin and 10 to 100 parts by weight of polyester fibers having a fiber diameter of 1 to 10 deniers, a fiber length of 0.5 to 50 mm and a fiber strength of 5 to 13 g/d, and then molding the resulting mixture. Also, U.S. Pat. No. 3,639,424 to Gray, Jr. et al., the proposes a composition including a polymer, such as polypropylene, and uniformly dispersed therein at least about 10% by weight of the composition staple length fiber, the fiber being of man-made polymers, such as poly(ethylene terephthalate) (PET) or poly(1,4-cyclohexylenedimethylene terephthalate).

Fiber reinforced polypropylene compositions are also proposed in PCT Publication WO 02/053629. More specifically, WO 02/053629 proposes a polymeric compound, comprising a thermoplastic matrix having a high flow during melt processing and polymeric fibers having lengths of from 0.1 mm to 50 mm. The polymeric compound comprises between 0.5 wt % and 10 wt % of a lubricant.

Various modifications to organic fiber reinforced polypropylene compositions are also known. For example, polyolefins modified with maleic anhydride or acrylic acid have been used as the matrix component to improve the interface strength between the synthetic organic fiber and the polyolefin, which was thought to enhance the mechanical properties of the molded product made therefrom.

Other background references include PCT Publication WO90/05164; EP Patent Application 0669372; U.S. Pat. No. 6,395,342 to Kadowaki et al.; EP Patent Application 1075918; U.S. Pat. No. 5,145,891 to Yasukawa et al., U.S. Pat. No. 5,145,892 to Yasukawa et al.; and EP Patent 0232522.

U.S. Pat. No. 3,304,282 to Cadus et al. proposes a process for the production of glass fiber reinforced high molecular weight thermoplastics in which the plastic resin is supplied to an extruder or continuous kneader, endless glass fibers are introduced into the melt and broken up therein, and the mixture is homogenized and discharged through a die. The glass fibers are supplied in the form of endless rovings to an injection or degassing port downstream of the feed hopper of the extruder.

U.S. Pat. No. 5,401,154 to Sargent proposes an apparatus for making a fiber reinforced thermoplastic material and forming parts therefrom. The apparatus includes an extruder having a first material inlet, a second material inlet positioned downstream of the first material inlet, and an outlet. A thermoplastic resin material is supplied at the first material inlet and a first fiber reinforcing material is supplied at the second material inlet of the compounding extruder, which discharges a molten random fiber reinforced thermoplastic material at the extruder outlet. The fiber reinforcing material may include a bundle of continuous fibers formed from a plurality of monofilament fibers. Fiber types disclosed include glass, carbon, graphite and Kevlar.

U.S. Pat. No. 5,595,696 to Schlarb et al. proposes a fiber composite plastic and a process for the preparation thereof and more particularly to a composite material comprising continuous fibers and a plastic matrix. The fiber types include glass, carbon and natural fibers, and can be fed to the extruder in the form of chopped or continuous fibers. The continuous fiber is fed to the extruder downstream of the resin feed hopper.

U.S. Pat. No. 6,395,342 to Kadowaki et al. proposes an impregnation process for preparing pellets of a synthetic organic fiber reinforced polyolefin. The process comprises the steps of heating a polyolefin at the temperature which is higher than the melting point thereof by 40 degree C. or more to lower than the melting point of a synthetic organic fiber to form a molten polyolefin; passing a reinforcing fiber comprising the synthetic organic fiber continuously through the molten polyolefin within six seconds to form a polyolefin impregnated fiber; and cutting the polyolefin impregnated fiber into the pellets. Organic fiber types include polyethylene terephthalate, polybutylene terephthalate, polyamide 6, and polyamide 66.

U.S. Pat. No. 6,419,864 to Scheuring et al. proposes a method of preparing filled, modified and fiber reinforced thermoplastics by mixing polymers, additives, fillers and fibers in a twin screw extruder. Continuous fiber rovings are fed to the twin screw extruder at a fiber feed zone located downstream of the feed hopper for the polymer resin. Fiber types disclosed include glass and carbon.

Application Ser. No. 11/318,363, filed Dec. 23, 2005, notes that consistently feeding PET fibers into a compounding extruder is a problem encountered during the production of polypropylene (PP)-PET fiber composites. Conventional gravimetric or vibrational feeders used in the metering and conveying of polymers, fillers and additives into the extrusion compounding process, while effective in conveying pellets or powder, are not effective in conveying cut fiber. Another issue encountered during the production of PP-PET fiber composites is adequately dispersing the PET fibers into the PP matrix while still maintaining the advantageous mechanical properties imparted by the incorporation of the PET fibers. More particularly, extrusion compounding screw configuration may impact the dispersion of PET fibers within the PP matrix, and extrusion compounding processing conditions may impact not only the mechanical properties of the matrix polymer, but also the mechanical properties of the PET fibers. Application Ser. No. 11/318,363, filed Dec. 23, 2005, proposes solutions to these problems.

U.S. Pat. No. 4,648,208 proposes an automobile door having a unit carrier on which built-in units, such as a window winding mechanism and window winder can be preassembled.

U.S. Pat. No. 4,882,842 proposes a modular trim panel unit with the preassembly of the interior trim panel for the door including one or more mechanical or electrical components.

U.S. Pat. No. 5,355,629 proposes a door for a vehicle that is assembled by joining three modules together to facilitate the assembly process.

U.S. Patent Publication No. 2003/02118356 proposes a door assembly that includes a molded door panel having a first side and a second side. The first side of the door panel is adapted to face into a passenger compartment of the motor vehicle. The second side of the door panel supports a belt line reinforcement, a lock and catch assembly and a window lift assembly. The door assembly so proposed is said to be adapted for joining with a door exterior.

Despite advances in the art, there remains a need for a modular door assembly which is both lightweight, modular in construction and, therefore, easy to assemble in the assembly plant and yet relatively inexpensive.

### SUMMARY OF THE INVENTION

Provided is a fiber reinforced polypropylene composite door core module. The door core module includes a module plate molded from a composition comprising at least 30 wt % polypropylene based resin, from 10 to 60 wt % organic fiber, from 0 to 40 wt % inorganic filler, and optionally lubricant (typically present at from 0 to 0.1 wt %), based on the total weight of the composition, the module plate having a first side and a second side.

In another aspect, a process for producing fiber reinforced polypropylene composite door core modules is also provided. The process includes the step of injection molding a composition to form the door core module, the door core module having a module plate having at least a first side and a second side, wherein the composition comprises at least 30 wt % polypropylene, from 10 to 60 wt % organic fiber, from 0 to 40 wt % inorganic filler, and optionally lubricant (typically present at from 0 to 0.1 wt %), based on the total weight of the composition.

In yet another aspect, provided is a process for making a fiber reinforced polypropylene composite door core module, comprising the steps of: feeding into a twin screw extruder hopper at least about 25 wt % of a polypropylene based resin with a melt flow rate of from about 20 to about 1500 g/10 minutes; continuously feeding by unwinding from one or more spools into the twin screw extruder hopper from about 5 wt % to about 40 wt % of an organic fiber; feeding into a twin screw extruder from about 10 wt % to about 60 wt % of an inorganic filler; extruding the polypropylene based resin, the organic fiber, and the inorganic filler through the twin screw extruder to form a fiber reinforced polypropylene composite melt; cooling the fiber reinforced polypropylene composite melt to form a solid fiber reinforced polypropylene composite; injection molding the fiber reinforced polypropylene composite to form the door core module, the door core module having a module plate having an first side and a second side.

It has surprisingly been found that high quality composite door core modules can be produced from the instant fiber reinforced polypropylene compositions, the resultant panels possessing a flexural modulus of at least 300,000 psi and exhibiting ductility during instrumented impact testing. Particularly surprising is the ability to make such composite door core modules using a wide range of polypropylenes as the matrix material, including some polypropylenes that, without fiber, are very brittle.

It has also been surprisingly found that organic fiber may be fed into a twin screw compounding extruder by continuously unwinding from one or more spools into the feed hopper of the twin screw extruder, and then chopped into ¼ inch to 1 inch lengths by the twin screws to form a fiber reinforced polypropylene based composite for use in producing high quality composite door core modules.

Numerous advantages result from the composite door core modules and the method of making disclosed herein and the uses/applications therefore.

For example, in exemplary embodiments of the present disclosure, the disclosed polypropylene fiber composite door core modules exhibit improved instrumented impact resistance.

In a further exemplary embodiment of the present disclosure, the disclosed polypropylene fiber composite door core modules exhibit improved flexural modulus.

In a further exemplary embodiment of the present disclosure, the disclosed polypropylene fiber composite door core modules do not splinter during instrumented impact testing.

In yet a further exemplary embodiment of the present disclosure, the disclosed polypropylene fiber composite door core modules exhibit fiber pull out during instrumented impact testing without the need for lubricant additives.

In yet a further exemplary embodiment of the present disclosure, the disclosed polypropylene fiber composite door core modules exhibit a higher heat distortion temperature compared to rubber toughened polypropylene.

In yet a further exemplary embodiment of the present disclosure, the disclosed polypropylene fiber composite door core modules exhibit a lower flow and cross flow coefficient of linear thermal expansion compared to rubber toughened polypropylene.

In still yet a further exemplary embodiment of the present disclosure, the disclosed polypropylene fiber composite door core modules exhibit the ability to provide excellent surface finishes.

In still yet a further exemplary embodiment of the present disclosure, the disclosed polypropylene fiber composite door core modules exhibit the requisite stiffness characteristics necessary for use as a load bearing member.

These and other advantages, features and attributes of the disclosed fiber reinforced polypropylene composite door core modules and method of making fiber reinforced polypropylene composite door core modules and their advantageous applications and/or uses will be apparent from the detailed description that follows, particularly when read in conjunction with the figures appended hereto.

### BRIEF DESCRIPTION OF THE DRAWINGS

FIG. 1 is an assembly plan drawing depicting a first form of a fiber reinforced polypropylene composite door core module, shown with other conventional door unit components;

FIG. 2 is an assembly plan drawing depicting a second form of a fiber reinforced polypropylene composite door core module, shown with other conventional door unit components;

FIG. 3 is a plan view of a door assembly showing the fiber reinforced polypropylene composite door core module of FIG. 2, as seen from the interior of a vehicle;

FIG. 4 is a section of the door assembly showing the fiber reinforced polypropylene composite door core module along the line 4-4 in FIG. 3;

FIG. 5 is a partial plan view of the door assembly showing the fiber reinforced polypropylene composite door core module according to FIGS. 2-4, but with a motor driven window winding mechanism instead of a manual window winding mechanism, seen from the inside of the vehicle;

FIG. 6 is an assembly plan depicting a third form of a fiber reinforced polypropylene composite door core module, shown with other conventional door unit components;

FIG. 7 is an assembly plan drawing of a fourth form of a fiber reinforced polypropylene composite door core module, shown with other conventional door unit components;

FIG. 8 depicts an exemplary schematic of the process for making fiber reinforced polypropylene composite door core modules of the instant invention;

FIG. 9 depicts an exemplary schematic of a twin screw extruder with a downstream feed port for making fiber reinforced polypropylene composite door core modules of the instant invention; and

FIG. 10 depicts an exemplary schematic of a twin screw extruder screw configuration for making fiber reinforced polypropylene composite door core modules of the instant invention.

### DETAILED DESCRIPTION OF THE INVENTION

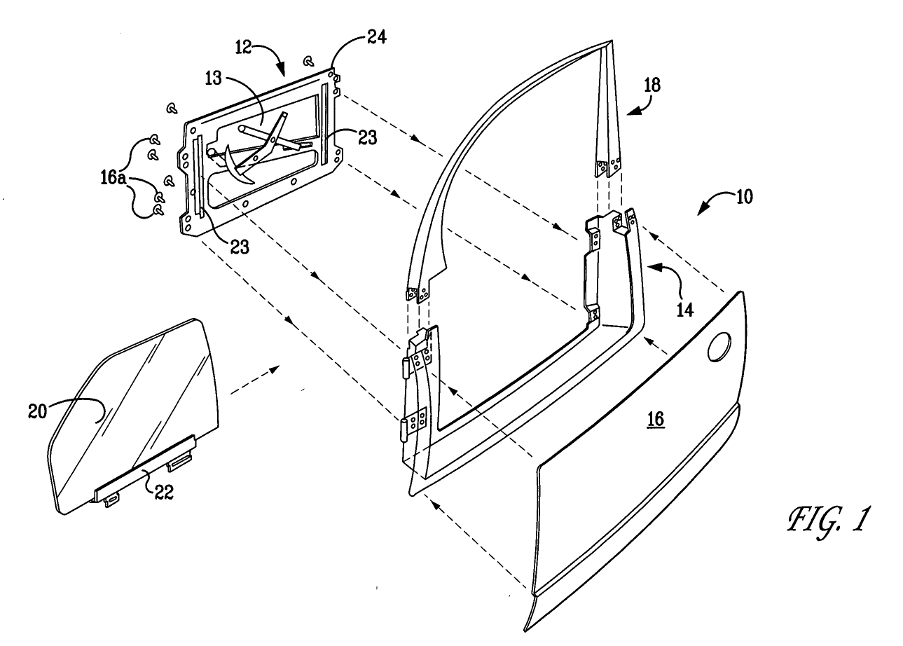

Reference is now made to FIGS. 1-10, wherein like numerals are used to designate like parts throughout.

Disclosed herein are fiber reinforced polypropylene composite door core modules and a process for making same. Composite vehicle door core modules of the type contemplated herein are generically depicted in FIGS. 1-7. In the case of the vehicle door core modules described below, while the invention concerns automobile doors, other types of use can be considered, e.g. aircraft or ship doors. All of the contemplated forms have the door core module in common, which permits the preassembly of important built-in unit parts, such as a window winder mechanism, with or without the window pane, and permits this without the presence of the actual vehicle, and at least in the case of an automobile or truck, independently of the main assembly line.

Referring to FIG. 1 a door assembly 10 for vehicles is schematically shown. A fiber reinforced polypropylene composite door core module 12 includes a module plate 24 molded from the fiber reinforced polypropylene composites disclosed herein. The composite door core module has been preassembled and is provided with a window winder mechanism 13. The fiber reinforced polypropylene composite door core module 12 is mounted on a door frame 14, which may employ a U-shaped bent box profile, although it is within the scope of the invention disclosed herein to also form the fiber reinforced polypropylene composite door core module together with door frame 14, as a unitary molded part, owing to the properties of the polypropylene composites disclosed herein. An interior door trim panel (not shown) is attached to door core module 12 or, alternatively, to door frame 14, in a conventional manner to form a completed door assembly 10.

When fiber reinforced polypropylene composite door core module 12 is formed as a component separate and apart from door frame 14, fasteners 16 may be used as shown in FIG. 1. On the other side of the door frame 14 the outer body shell 16a is disposed by the folding of the corresponding peripheral edges. In the case of a door with a window frame 18, the latter may be secured on the door assembly 10, e.g. on the door frame 14. Lastly a window pane 20 may be inserted in the lateral guide rails 23 on the fiber reinforced polypropylene composite door core module 12 and connected via a winding rail 22 on the lower pane transverse edge with the window winder 13. The insertion of the window 20 is done before the connection of the fiber reinforced polypropylene composite door core module 12 and the door frame 14, although other configurations are within the scope of the invention contemplated herein.

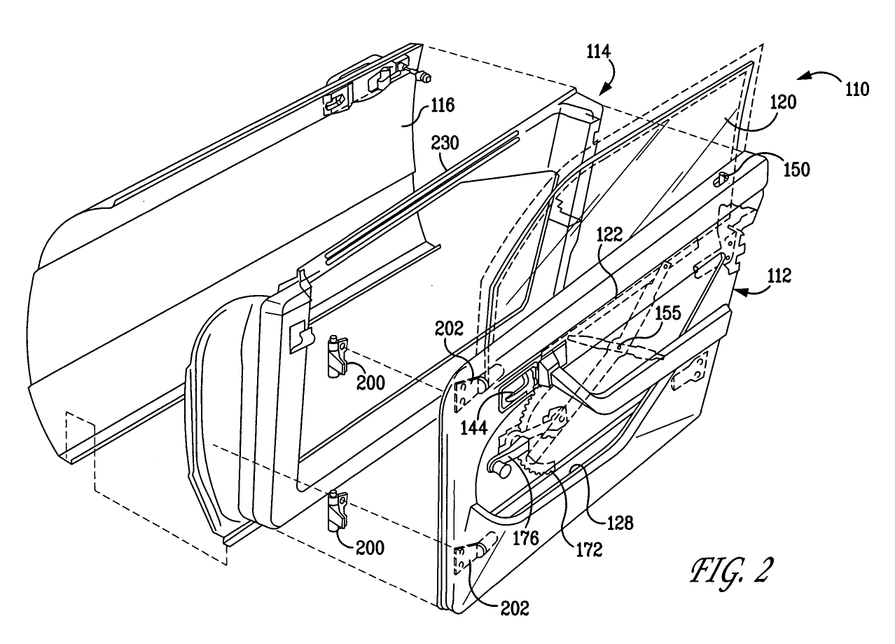

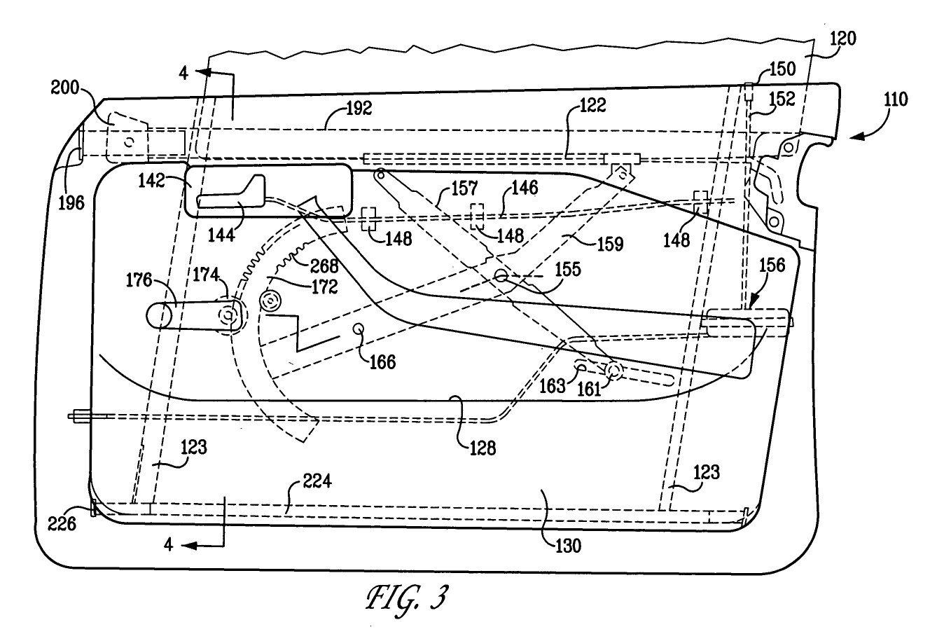

FIG. 2 shows an assembly plan depicting a second form of a fiber reinforced polypropylene composite door core module 112, shown with other conventional door unit components. FIGS. 3-5 show detailed views of this door assembly 110.

Door assembly 110 is made in 3 parts; i.e. it consists of fiber reinforced polypropylene composite door core module 112, a door frame 114, as well as an outer body shell 116. The door assembly 110 is shown without a window frame; but it can be fitted with one. In FIG. 2 the broken outline shows such a window frame, which, as opposed to FIG. 1, is mounted on the fiber reinforced polypropylene composite door core module 112. The window pane 120 is also mounted on the preassembled fiber reinforced polypropylene composite door core module 112.

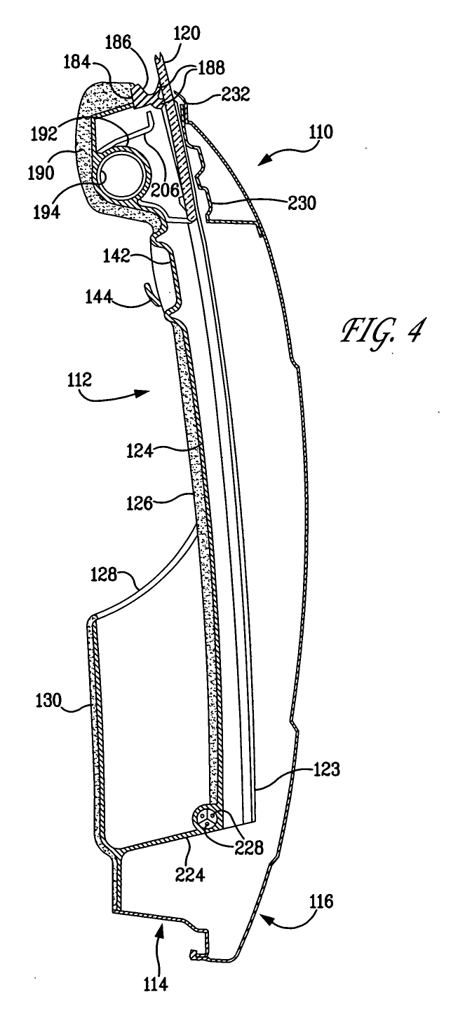

As can be seen in FIG. 4, the fiber reinforced polypropylene composite door core module 112 consists of a module plate 124, molded from the fiber reinforced polypropylene compositions disclosed herein. Module plate 124 may optionally be provided with a foamed foam material layer 126 on the inside facing the vehicle compartment. The foam layer 126 may be flocked or covered with fabric in a conventional manner. Preferably, and owing to the high quality surface finishes that can be achieved with the fiber reinforced polypropylene composites disclosed herein, module plate 124 of fiber reinforced polypropylene composite door core module 112 may be molded in color and provided with an attractive surface design, such as a pebble grain, for direct exposure to a vehicle's passenger compartment.

In the area of the lower half of the fiber reinforced polypropylene composite door core module 112, there may be provided a map pocket 128; the front wall 130 extending upwards of the map pocket 128 and may be finished in a manner similar to module plate 124. FIG. 4 shows both the door frame 114 as well as the outer body shell 116. The module plate 124 can, of course, be reinforced where needed by including reinforcing members, such as ribs or the like.

FIGS. 3 and 4, each show a grip 142 in the module plate 124 (not shown FIG. 3) for an inner door latch 144. A lock actuating rod 146 (not shown FIG. 4) leads from the door latch 144 to a conventional door lock (not shown). To guide this rod 146 there are rod guide elements 148 (schematically shown) on the module plate 124 in FIG. 3.

The locking of the lock from inside the vehicle is performed by a safety-knob 150 visible in FIGS. 2-3, which is connected to the lock via a second lock actuating rod in FIG. 3. On the opposite end of rod 152 there is a membrane (not shown) 154 of a pneumatic reverse switch 156, secured via a plate (not shown). The reverse switch 156 is part of a conventional central locking system, as may be appreciated.

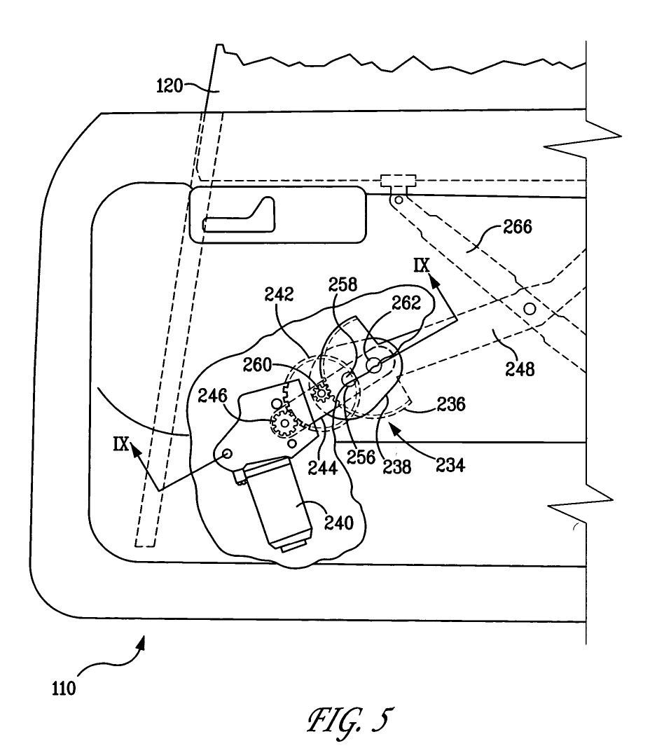

The fiber reinforced polypropylene composite door core module 112 may be provided, before assembly on the main assembly line with the outer body shell 116 and the door frame 114, with a window winder mechanism, wherein a choice can be made between a manually actuated window winder mechanism (FIG. 2-3) or an electrically driven window winder mechanism (FIG. 5). The two window winder types may have in common a window winder mechanism made of two winder arms 157 and 159 linked together at a rotary point 155 as well as a guide for the window pane 120 in the side rails 123 (FIG. 3) formed on the module plate 124. Other conventional window winder mechanisms may be employed, as those skilled in the art will plainly recognize.

Both the winder arms 157 and 159 engage with one of their ends with the winder rail 122, while at least one winder arm is displaceably mounted along the winder rail 122. The other end of winder arm 157 is fitted with a roller 161, which rolls along a guide groove 163 in the module plate 124.

The winder arm 159 is mounted on a rotary bearing bolt 166, which in turn is preferably rigidly secured as an insertion part on the module plate 124. On the end of the winder arm 159 remote from the winder rail 122, the arm 159 is provided with an arcuate cog segment 172 which meshes with a pinion 174. This pinion is in turn coupled via a coupling (not shown) to a crankhandle 176 on the inside of the fiber reinforced polypropylene composite door core module 112. As may be appreciated, all of the window winder mechanism parts can be easily assembled on the fiber reinforced polypropylene composite door core module 112.

The window pane 120 can also be preassembled on the fiber reinforced polypropylene composite door core module 112 since the side guide rails 123 provide the necessary support. At vertically-upward projecting transverse edge 184 of module plate 124, there is a seal 186 with two parallel superimposed sealing lips 188 (see FIG. 4) abutting the inside of the window pane 120, as is conventional. In this top transverse edge area, module plate 124 is approximately box-shaped and curved inwardly and may, optionally, be provided with a thick foam layer 190 as an impact cushion.

On the inside of the box-shaped curve of the unitary module plate 124 there is a hollow cylindrical formation 192, into which reinforcing tube 194 is inserted, as seen in FIGS. 3 and/or 4. On both ends of reinforcing tube 194, respectively, there is a base part with a tubular piece inserted, i.e. a hinge-end base part 196 in the left-hand tube end and a lock-end base part (not shown) in the right-hand end. The hinge-end base part 196 can provide the base for a door hinge shown in FIG. 2 as 200, while, optionally, a further angle can be used to connect the two parts. When the door is closed, therefore the reinforcing tube 194 is clamped firmly between the A and the B columns and provides a cage that, in the event of an accident, the lateral or frontal forces are diverted directly to the mechanically stable A and B columns of the car body.

As shown in FIGS. 3 and/or 4, in the lower edge area of the fiber reinforced polypropylene composite door core module 112, a reinforcing tube 224 can also be provided, which is formed in a correspondingly tubular formation on the unitary module plate 124 in the area of the base of the map pocket 128. On its end near the A column (at left in FIG. 3), again, a hinge base part 226 is inserted. The reinforcing tube 224 can also advantageously be used as a conduit for electric cables as shown in FIG. 4.

On the fiber reinforced polypropylene composite door core module 112, further unit parts (not shown) can be mounted, e.g. an electronic control unit for the window winder mechanism or for adjustment of the nearest seat. These electronic components may be inserted in corresponding recesses which are open so that adequate cooling is ensured. Further, on the fiber reinforced polypropylene composite door core module 112, an entry light or an interior light can be placed. Advantageously, the preassembly of the fiber reinforced polypropylene composite door core module 112 is carried out independently of the main assembly line on an ancillary or preassembly line or optionally at a different factory. Further the outer door shell 116 can also be independently joined to the door frame 114, away from the main assembly line. It may be noted that the door frame 114 is closed by a top profiled transverse sheet 230 (FIG. 2). On the top edge of the transverse sheet 230 there is a sealing lip 232 (FIG. 4) in contact with the outside of the windowpane 120.

The fiber reinforced polypropylene composite door core module 112 may also be provided with an electrically driven window winder mechanism 234, as shown in simplified form in FIG. 5. The winding mechanism is unchanged as far as the replacement of the arcuate cog segment 172 by an approximately semi-circular cog sector 236. A counter base plate 244 partly visible in FIG. 5, forms a base both for the motor pinion 246 of the gear motor 240 as well as for the double cogwheel 242, and also forms a rotational point for the winder arm 248 bearing the cog segment 236. The counter-baseplate 244 ensures adequate mechanical stability of the gear.

The window winder gear motor 240 is inserted in a receptacle 250 which largely encloses it and which is formed in module plate 124. The gear motor 240 is attached by means of a screw connection 254 passing through the peripheral flange of the motor on module plate 124. A baseplate 238 is provided and has a central circular aperture 256 into which a corresponding projection 258 of module plate 124 penetrates to form a positive connection after the pressing of the baseplate 238 onto module plate 124. The baseplate 238 has two base bolts, a base bolt 262 for the winder arm 248 and a base bolt 260 for the double cogwheel 242. The guide groove 162 for the lower end (not shown) of the winder arm 266 is unchanged, as are the lateral guide rails 123 for the window pane 120.

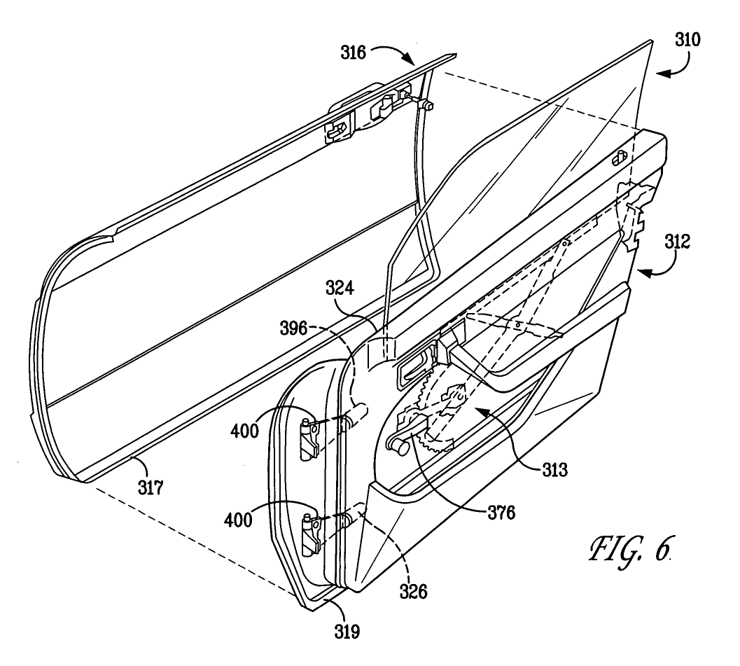

FIG. 6 is an assembly plan depicting a third form of a fiber reinforced polypropylene composite door core module, shown with other conventional door unit components, to form a door assembly 310. Parts of the door assembly 310 which correspond to those of door 110 of FIGS. 2-5 are marked with similar reference numerals, increased by 200 in each case.

In contrast to door assembly 10 of FIG. 1 or to door assembly 110 of FIGS. 2-5, door assembly 310 is essentially in two parts, since the outer body shell 316 is mounted without an intermediate doorframe directly to the fiber reinforced polypropylene composite door core module 312, which includes a doorframe's corresponding structure, the door core module 312 otherwise corresponding in design to the fiber reinforced polypropylene composite door core module 112. For example, reference is made to window winder mechanism 313, driven by a crankhandle 376, but which can also be driven by a motor (not shown). The hinge base parts 396 and 326 can also be inserted in reinforcing tubes (not shown), on which the door hinges 400 can be assembled.

To accept the peripheral edge 317 of the outer body shell 316 the module plate 324 of the fiber reinforced polypropylene composite door core module 312 may be provided with a U-shaped peripheral fold (seen in cross-section) 319. A seal (not shown) which embraces the peripheral edge 317 of the outer body shell 316 can also be inserted in the peripheral fold 319. To seal off the bottom transverse edge of door 310 against the vehicle body, a corresponding sealing lip can also be located on the fiber reinforced polypropylene composite door core module 312, in a conventional manner.

Should it be necessary after assembly of the door 310, e.g. for repair work, to be able to reach the unit parts on the outside of the fiber reinforced polypropylene composite door core module 312, the latter can be removed from the outer body shell 316, since the two parts 316 and 312 are detachably connected by clipping, and/or riveting and/or by bolting to each other.

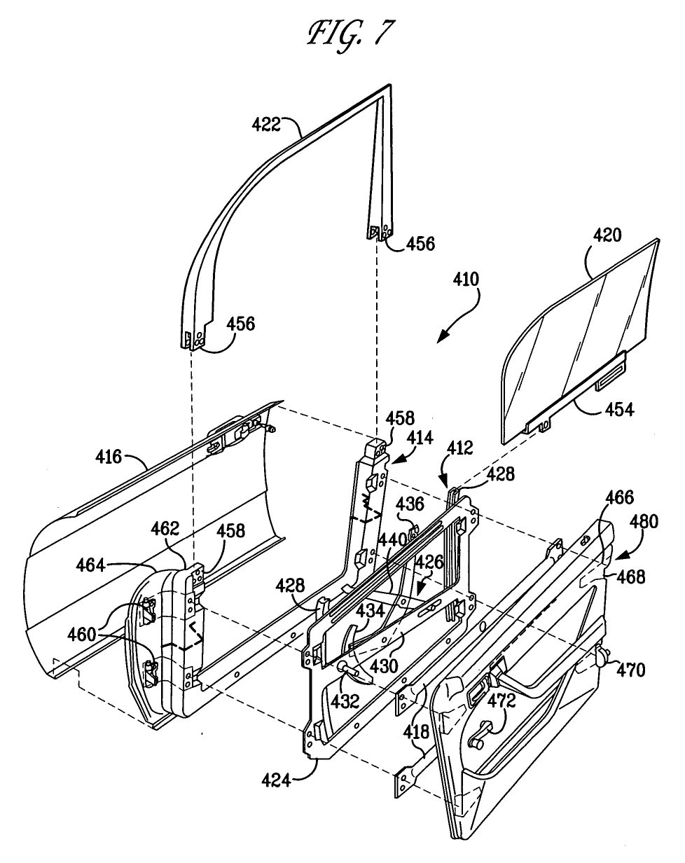

Referring now to FIG. 7, an assembly plan depicting a fourth form of a fiber reinforced polypropylene composite door core module, shown with other conventional door unit components, to form a door assembly 410. Parts of the door assembly 410 which correspond to those of door 110 of FIGS. 2-5 are marked with the same reference numerals, increased by 300 in each case. The door assembly 410 consists of an outer body shell 416, a door frame 414, fiber reinforced polypropylene composite door core module 412, shown with two horizontal reinforcing tubes 418, an interior trim panel 480, a window frame 422 to be mounted on door frame 414, and a window pane 420.

The fiber reinforced polypropylene composite door core module 412 is already partly assembled, i.e. with a crossed arm window winder mechanism 426 and with lateral guide rails 428 for the window pane 420. The fiber reinforced polypropylene composite door core module 412 is shown having a simple rectangular module plate 424, with a center strut 430 that serves as the rotary bearing for a drive pinion 432 as well as a rotary bearing for an arm 436 supporting the cog sector 434 of the window winder mechanism 426. Of course, other configurations of fiber reinforced polypropylene composite door core module 412 are contemplated and within the scope of the present invention.

After suspension of the winder rail 454 mounted on the lower edge of the window pane 420 on the corresponding ends of the arms 436 and 440 of the window winder mechanism 426 and after threading the window pane 420 into the lateral guide rails 428 and after adjustment, the fiber reinforced polypropylene composite door core module 412 can be assembled for further processing either with interior trim panel 480 with the reinforcing tubes 418 interposed, or it can be assembled with the door frame 414, which optionally is provided either previously or later with the outer body shell 416.

Alternatively, the fiber reinforced polypropylene composite door core module 412 may be joined together the door frame 414 (optionally with the outer body shell 416), and the trim panel 480, simultaneously, and by securing them to each other, e.g. by the insertion of the corresponding bolts. Either before or during this assembly step, the window frame 422 can be connected with the door frame 414, if desired.

To install the window frame 422, fork-type securing links 456 are connected to a corresponding projection 458 of door frame 414. For fastening, it is only necessary to insert rivet bolts through the correspondingly aligned holes of the links 456 and projections 458 and then to fasten them.

As shown, the two reinforcing tubes 418 are connected at their front end, respectively, with door hinges 460 and, respectively, via a multi-angled connecting link 462. They extend, respectively, on the outside of the door frame 414 and are therefore not visible when the door 410 is assembled. The hinges 460 are arranged on an apron-like section 464 which may project laterally from the actual box profile of the door frame 414. They are rigidly connected in a manner not shown with the hinges 460. The bolts for connection of the parts 414, 412, 480 are then first inserted through the holes of the connecting links, finally ensuring a rigid connection between the links 462 and the reinforcing tubes 418.

The interior trim panel 480 is provided with a door lock 466 which is schematically shown by the broken outline in FIG. 7, which after the assembly of the parts 414, 412 and 480 is connected by bolts directly with the top reinforcing tube 418, so that a direct force transfer path is formed from the door lock 466 or the locking arrangement 468 on the door side via the top reinforcing tube 418 and the top connecting link 462 to the top hinge 460. A further such force transfer path results between the second locking arrangement 470 disposed under locking arrangement 468 via the lower reinforcing tube 418 and the lower connecting link 462 to the lower door hinge 460.

It must also be noted that the interior trim panel 480 can be also advantageously be made of fiber reinforced polypropylene composite, which provides an advantageously low weight and high strength and stiffness, as will be detailed more fully below. Further the interior trim panel 480 can be designed on the inside to included foam upholstery. In FIG. 7, a window winder hand crank 472 is seen, which after assembly of the parts 412 and 480 is located on the shaft of the drive pinion 432. Instead of a crank drive, a motor drive can be mounted, as is conventional. As may be appreciated, the decision on the type of drive can be made at a relatively late point in time, since the same fiber reinforced polypropylene composite door core module 412 may be designed to accommodate both drive mechanisms.

As may be appreciated, owing to the unique characteristics of the fiber reinforced polypropylene composites contemplated herein, a fiber reinforced polypropylene composite door core module can optionally be integrally molded together with a door frame and outer body panel. In such a case, following assembly of the inner door components, a conventional trim panel may be attached thereto to form a door assembly. Alternatively, a single door assembly can employ a plurality of smaller fiber reinforced polypropylene composite door core modules, e.g., a module for the window winder mechanism and a module for containing electrical components, such as motors, lights and/or speakers. These and other variations are within the scope of the present invention.

Advantageously, the fiber reinforced polypropylene composite door core modules contemplated herein are molded from a composition comprising a combination of a polypropylene based matrix with organic fiber and inorganic filler, which in combination yield door core modules molded from the compositions with a flexural modulus of at least 300,000 psi and ductility during instrumented impact testing (15 mph, −29° C., 25 lbs). The fiber reinforced polypropylene composite door core modules employ a polypropylene based matrix polymer with an advantageous high melt flow rate that does not sacrifice impact resistance. In addition, the fiber reinforced polypropylene composite door core modules disclosed herein do not splinter during instrumented impact testing.

The fiber reinforced polypropylene composite door core modules disclosed herein simultaneously have desirable stiffness, as measured by having a flexural modulus of at least 300,000 psi, and toughness, as measured by exhibiting ductility during instrumented impact testing. The fiber reinforced polypropylene composite door core modules contemplated herein have a flexural modulus of at least 350,000 psi, or at least 370,000 psi, or at least 390,000 psi, or at least 400,000 psi, or at least 450,000 psi. Still more particularly, the fiber reinforced polypropylene composite door core modules have a flexural modulus of at least 600,000 psi, or at least 800,000 psi. It is also believed that having a weak interface between the polypropylene matrix and the fiber contributes to fiber pullout; and, therefore, may enhance toughness. Thus, there is no need to add modified polypropylenes to enhance bonding between the fiber and the polypropylene matrix, although the use of modified polypropylene may be advantageous to enhance the bonding between a filler, such as talc or wollastonite and the matrix. In addition, in one embodiment, there is no need to add lubricant to weaken the interface between the polypropylene and the fiber to further enhance fiber pullout. Some embodiments also display no splintering during instrumented dart impact testing, which yield a further advantage of not subjecting a person in close proximity to the impact to potentially harmful splintered fragments.

The fiber reinforced polypropylene composite door core modules disclosed herein are formed from a composition that includes at least 30 wt %, based on the total weight of the composition, of polypropylene as the matrix resin. In a particular embodiment, the polypropylene is present in an amount of at least 30 wt %, or at least 35 wt %, or at least 40 wt %, or at least 45 wt %, or at least 50 wt %, or in an amount within the range having a lower limit of 30 wt %, or 35 wt %, or 40 wt %, or 45 wt %, or 50 wt %, and an upper limit of 75 wt %, or 80 wt %, based on the total weight of the composition. In another embodiment, the polypropylene is present in an amount of at least 25 wt %.

The polypropylene used as the matrix resin in the fiber reinforced polypropylene composite door core modules is not particularly restricted and is generally selected from the group consisting of propylene homopolymers, propylene-ethylene random copolymers, propylene-α-olefin random copolymers, propylene block copolymers, propylene impact copolymers, and combinations thereof. In a particular embodiment, the polypropylene is a propylene homopolymer. In another particular embodiment, the polypropylene is a propylene impact copolymer comprising from 78 to 95 wt % homopolypropylene and from 5 to 22 wt % ethylene-propylene rubber, based on the total weight of the impact copolymer. In a particular aspect of this embodiment, the propylene impact copolymer comprises from 90 to 95 wt % homopolypropylene and from 5 to 10 wt % ethylene-propylene rubber, based on the total weight of the impact copolymer.

The polypropylene of the matrix resin may have a melt flow rate of from about 20 to about 1500 g/10 min. In a particular embodiment, the melt flow rate of the polypropylene matrix resin is greater than 100 g/10 min, and still more particularly greater than or equal to 400 g/10 min. In yet another embodiment, the melt flow rate of the polypropylene matrix resin is about 1500 g/10 min. The higher melt flow rate permits for improvements in processability, throughput rates, and higher loading levels of organic fiber and inorganic filler without negatively impacting flexural modulus and impact resistance.

In a particular embodiment, the matrix polypropylene contains less than 0.1 wt % of a modifier, based on the total weight of the polypropylene. Typical modifiers include, for example, unsaturated carboxylic acids, such as acrylic acid, methacrylic acid, maleic acid, itaconic acid, fumaric acid or esters thereof, maleic anhydride, itaconic anhydride, and derivates thereof. In another particular embodiment, the matrix polypropylene does not contain a modifier. In still yet another particular embodiment, the polypropylene based polymer further includes from about 0.1 wt % to less than about 10 wt % of a polypropylene based polymer modified with a grafting agent. The grafting agent includes, but is not limited to, acrylic acid, methacrylic acid, maleic acid, itaconic acid, fumaric acid or esters thereof, maleic anhydride, itaconic anhydride, and combinations thereof.

The polypropylene may further contain additives commonly known in the art, such as dispersants, lubricants, flame-retardants, antioxidants, antistatic agents, light stabilizers, ultraviolet light absorbers, carbon black, nucleating agents, plasticizers, and coloring agents such as dyes or pigments. The amount of additive, if present, in the polypropylene matrix is generally from 0.1 wt %, or 0.5 wt %, or 2.5 wt %, to 7.5 wt %, or 10 wt %, based on the total weight of the matrix. Diffusion of additive(s) during processing may cause a portion of the additive(s) to be present in the fiber.

The invention is not limited by any particular polymerization method for producing the matrix polypropylene, and the polymerization processes described herein are not limited by any particular type of reaction vessel. For example, the matrix polypropylene can be produced using any of the well known processes of solution polymerization, slurry polymerization, bulk polymerization, gas phase polymerization, and combinations thereof. Furthermore, the invention is not limited to any particular catalyst for making the polypropylene, and may, for example, include Ziegler-Natta or metallocene catalysts.

The fiber reinforced polypropylene composite door core modules contemplated herein are formed from compositions that also generally include at least 10 wt %, based on the total weight of the composition, of an organic fiber. In a particular embodiment, the fiber is present in an amount of at least 10 wt %, or at least 15 wt %, or at least 20 wt %, or in an amount within the range having a lower limit of 10 wt %, or 15 wt %, or 20 wt %, and an upper limit of 50 wt %, or 55 wt %, or 60 wt %, or 70 wt %, based on the total weight of the composition. In another embodiment, the organic fiber is present in an amount of at least 5 wt % and up to 40 wt %.

The polymer used as the fiber is not particularly restricted and is generally selected from the group consisting of polyalkylene terephthalates, polyalkylene naphthalates, polyamides, polyolefins, polyacrylonitrile, and combinations thereof. In a particular embodiment, the fiber comprises a polymer selected from the group consisting of polyethylene terephthalate (PET), polybutylene terephthalate, polyamide and acrylic. In another particular embodiment, the organic fiber comprises PET.

In one embodiment, the fiber is a single component fiber. In another embodiment, the fiber is a multicomponent fiber, wherein the fiber is formed from a process in which at least two polymers are extruded from separate extruders and meltblown or spun together to form one fiber. In a particular aspect of this embodiment, the polymers used in the multicomponent fiber are substantially the same. In another particular aspect of this embodiment, the polymers used in the multicomponent fiber are different from each other. The configuration of the multicomponent fiber can be, for example, a sheath/core arrangement, a side-by-side arrangement, a pie arrangement, an islands-in-the-sea arrangement, or a variation thereof. The fiber may also be drawn to enhance mechanical properties via orientation, and subsequently annealed at elevated temperatures, but below the crystalline melting point to reduce shrinkage and improve dimensional stability at elevated temperature.

The length and diameter of the fibers employed in the fiber reinforced polypropylene composite door core modules contemplated herein are not particularly restricted. In a particular embodiment, the fibers have a length of ¼ inch, or a length within the range having a lower limit of ⅛ inch, or ⅙ inch, and an upper limit of ⅓ inch, or ½ inch. In another particular embodiment, the diameter of the fibers is within the range having a lower limit of 10 μm and an upper limit of 100 μm.

The fiber may further contain additives commonly known in the art, such as dispersants, lubricants, flame-retardants, antioxidants, antistatic agents, light stabilizers, ultraviolet light absorbers, carbon black, nucleating agents, plasticizers, and coloring agents such as dyes or pigments.

The fiber used to make the fiber reinforced polypropylene composite door core modules disclosed herein is not limited by any particular fiber form. For example, the fiber can be in the form of continuous filament yarn, partially oriented yarn, or staple fiber. In another embodiment, the fiber may be a continuous multifilament fiber or a continuous monofilament fiber.

The compositions employed in the fiber reinforced polypropylene composite door core modules disclosed herein optionally include inorganic filler in an amount of at least 1 wt %, or at least 5 wt %, or at least 10 wt %, or in an amount within the range having a lower limit of 0 wt %, or 1 wt %, or 5 wt %, or 10 wt %, or 15 wt %, and an upper limit of 25 wt %, or 30 wt %, or 35 wt %, or 40 wt %, based on the total weight of the composition. In yet another embodiment, the inorganic filler may be included in the polypropylene fiber composite in the range of from 10 wt % to about 60 wt %. In a particular embodiment, the inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, magnesium oxysulfate, titanium oxide, zinc oxide, zinc sulfate, and combinations thereof. The talc may have a size of from about 1 to about 100 microns.

Preferred for use in the compositions employed in the fiber reinforced polypropylene composite door core modules contemplated herein is high aspect ratio talc. Although aspect ratio can be calculated by dividing the average particle diameter of the talc by the average thickness using a conventional microscopic method, this is a difficult and tedious technique. A particularly useful indication of aspect ratio is known in the art as “lamellarity index,” which is a ratio of particle size measurements. Therefore, as used herein, by “high aspect ratio” talc is meant talc having an average lamellarity index greater than or equal to about 4 or greater than or equal to about 5. A talc having utility in the compositions disclosed herein preferably has a specific surface area of at least 14 square meters/gram.

In one particular embodiment, at a high talc loading of up to about 60 wt %, the polypropylene fiber composite exhibited a flexural modulus of at least about 750,000 psi and no splintering during instrumented impact testing (15 mph, −29° C., 25 lbs). In another particular embodiment, at a low talc loading of as low as 10 wt %, the polypropylene fiber composite exhibited a flexural modulus of at least about 325,000 psi and no splintering during instrumented impact testing (15 mph, −29° C., 25 lbs). In addition, wollastonite loadings of from 5 wt % to 60 wt % in the polypropylene fiber composite yielded an outstanding combination of impact resistance and stiffness.

In another particular embodiment, a fiber reinforced polypropylene composition including a polypropylene based resin with a melt flow rate of 80 to 1500, 10 to 15 wt % of polyester fiber, and 50 to 60 wt % of inorganic filler displayed a flexural modulus of 850,000 to 1,200,000 psi and did not shatter during instrumented impact testing at −29 degrees centigrade, tested at 25 pounds and 15 miles per hour. The inorganic filler includes, but is not limited to, talc and wollastonite. This combination of stiffness and toughness is difficult to achieve in a polymeric based material. In addition, the fiber reinforced polypropylene composition has a heat distortion temperature at 66 psi of greater than 100 degrees centigrade, and a flow and cross flow coefficient of linear thermal expansion of 2.2×10⁻⁵ and 3.3×10⁻⁵ per degree centigrade respectively. In comparison, rubber toughened polypropylene has a heat distortion temperature of 94.6 degrees centigrade, and a flow and cross flow thermal expansion coefficient of 10×10⁻⁵ and 18.6×10⁻⁵ per degree centigrade respectively

The fiber reinforced polypropylene composite door core modules are made by forming the fiber-reinforced polypropylene composition and then injection molding the composition to form the door core module. The invention is not limited by any particular method for forming the compositions. For example, the compositions can be formed by contacting polypropylene, organic fiber, and optional inorganic filler in any of the well known processes of pultrusion or extrusion compounding. In a particular embodiment, the compositions are formed in an extrusion compounding process. In a particular aspect of this embodiment, the organic fibers are cut prior to being placed in the extruder hopper. In another particular aspect of this embodiment, the organic fibers are fed directly from one or more spools into the extruder hopper.

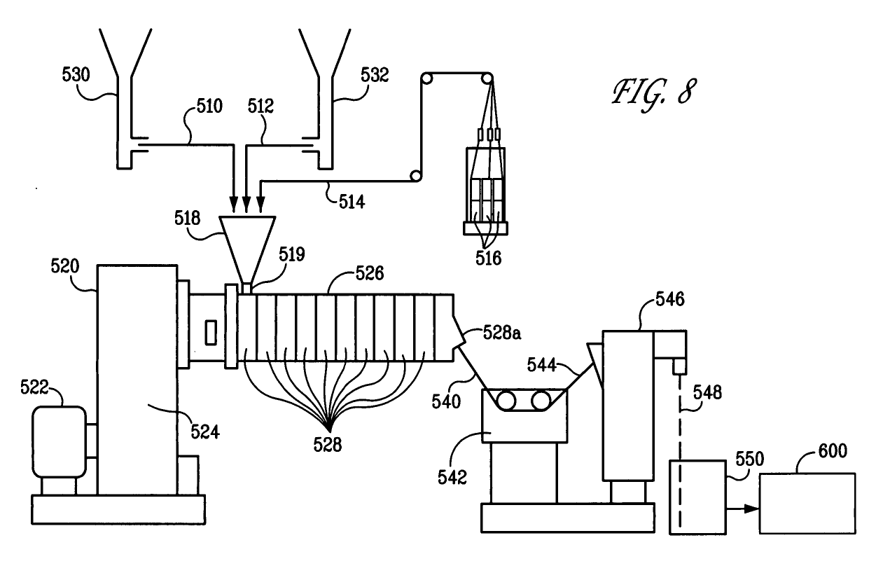

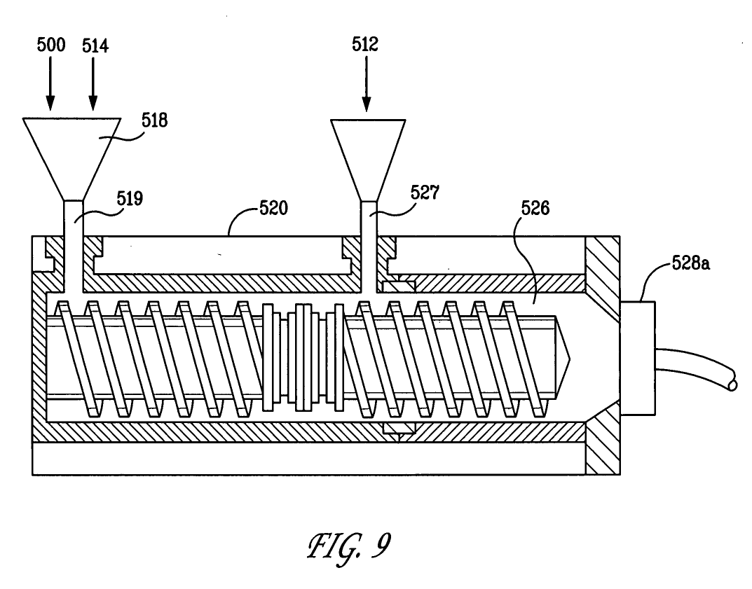

Referring now to FIG. 8, an exemplary schematic of the process for making fiber reinforced polypropylene composite door core modules of the instant invention is shown. Polypropylene based resin 510, inorganic filler 512, and organic fiber 514 continuously unwound from one or more spools 516 are fed into the extruder hopper 518 of a twin screw compounding extruder 520. The extruder hopper 518 is positioned above the feed throat 519 of the twin screw compounding extruder 520. The extruder hopper 518 may alternatively be provided with an auger (not shown) for mixing the polypropylene based resin 510 and the inorganic filler 512 prior to entering the feed throat 519 of the twin screw compounding extruder 520. In an alternative embodiment, as depicted in FIG. 9, the inorganic filler 512 may be fed to the twin screw compounding extruder 520 at a downstream feed port 527 (not shown) in the extruder barrel 526 positioned downstream of the extruder hopper 518, while the polypropylene based resin 510 and the organic fiber 514 are still metered into the extruder hopper 518.

Referring again to FIG. 8, polypropylene based resin 510 is metered to the extruder hopper 518 via a feed system 530 for accurately controlling the feed rate. Similarly, the inorganic filler 512 is metered to the extruder hopper 518 via a feed system 532 for accurately controlling the feed rate. The feed systems 530, 532 may be, but are not limited to, gravimetric feed system or volumetric feed systems. Gravimetric feed systems are particularly preferred for accurately controlling the weight percentage of polypropylene based resin 510 and inorganic filler 512 being fed to the extruder hopper 518. The feed rate of organic fiber 514 to the extruder hopper 518 is controlled by a combination of the extruder screw speed, number of fiber filaments and the thickness of each filament in a given fiber spool, and the number of fiber spools 516 being unwound simultaneously to the extruder hopper 518. The higher the extruder screw speed measured in revolutions per minute (rpms), the greater will be the rate at which organic fiber 514 is fed to the twin screw compounding screw 520. The rate at which organic fiber 514 is fed to the extruder hopper also increases with the greater the number of filaments within the organic fiber 514 being unwound from a single fiber spool 516, the greater filament thickness, the greater the number fiber spools 516 being unwound simultaneously, and the rotations per minute of the extruder.

The twin screw compounding extruder 520 includes a drive motor 522, a gear box 524, an extruder barrel 526 for holding two screws (not shown), and a strand die 528a. The extruder barrel 526 is segmented into a number of heated temperature controlled zones 528. As depicted in FIG. 8, the extruder barrel 526 includes a total of ten temperature control zones 528. The two screws within the extruder barrel 526 of the twin screw compounding extruder 520 may be intermeshing or non-intermeshing, and may rotate in the same direction (co-rotating) or rotate in opposite directions (counter-rotating). From a processing perspective, the melt temperature must be maintained above that of the polypropylene based resin 510, and far below the melting temperature of the organic fiber 514, such that the mechanical properties imparted by the organic fiber will be maintained when mixed into the polypropylene based resin 510. In one exemplary embodiment, the barrel temperature of the extruder zones did not exceed 154° C. when extruding PP homopolymer and PET fiber, which yielded a melt temperature above the melting point of the PP homopolymer, but far below the melting point of the PET fiber. In another exemplary embodiment, the barrel temperatures of the extruder zones are set at 185° C. or lower.

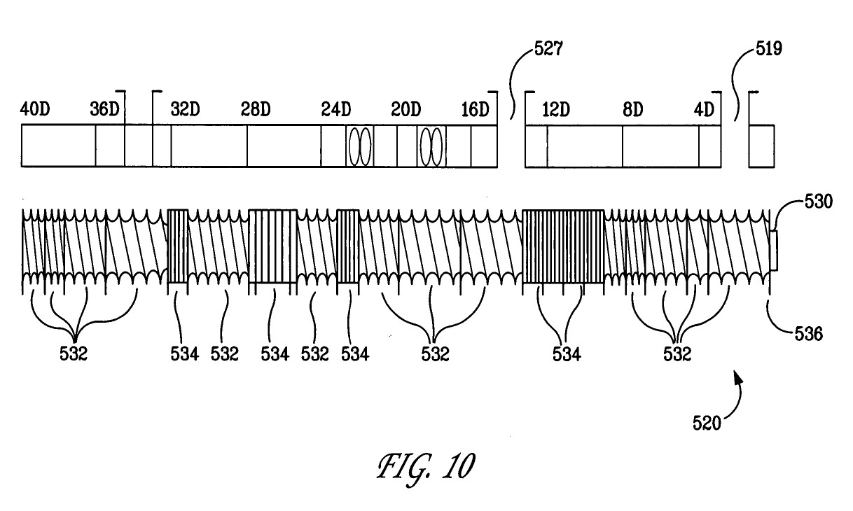

An exemplary schematic of a twin screw compounding extruder 520 screw configuration for making fiber reinforced polypropylene composites is depicted in FIG. 10. The feed throat 519 allows for the introduction of polypropylene based resin, organic fiber, and inorganic filler into a feed zone of the twin screw compounding extruder 520. The inorganic filler may be optionally fed to the extruder 520 at the downstream feed port 527. The twin screws 530 include an arrangement of interconnected screw sections, including conveying elements 532 and kneading elements 534. The kneading elements 534 function to melt the polypropylene based resin, cut the organic fiber lengthwise, and mix the polypropylene based melt, chopped organic fiber and inorganic filler to form a uniform blend. More particularly, the kneading elements function to break up the organic fiber into about ⅛ inch to about 1 inch fiber lengths. A series of interconnected kneading elements 534 is also referred to as a kneading block. U.S. Pat. No. 4,824,256 to Haring, et al., herein incorporated by reference in its entirety, discloses co-rotating twin screw extruders with kneading elements. The first section of kneading elements 534 located downstream from the feed throat is also referred to as the melting zone of the twin screw compounding extruder 520. The conveying elements 532 function to convey the solid components, melt the polypropylene based resin, and convey the melt mixture of polypropylene based polymer, inorganic filler and organic fiber downstream toward the strand die 528 (see FIG. 8) at a positive pressure.

The position of each of the screw sections as expressed in the number of diameters (D) from the start 536 of the extruder screws 530 is also depicted in FIG. 10. The extruder screws in FIG. 10 have a length to diameter ratio of 40/1, and at a position 32D from the start 536 of screws 530, there is positioned a kneading element 534. The particular arrangement of kneading and conveying sections is not limited to that as depicted in FIG. 10, however one or more kneading blocks consisting of an arrangement of interconnected kneading elements 534 may be positioned in the twin screws 530 at a point downstream of where organic fiber and inorganic filler are introduced to the extruder barrel. The twin screws 530 may be of equal screw length or unequal screw length. Other types of mixing sections may also be included in the twin screws 530, including, but not limited to, Maddock mixers, and pin mixers.

Referring once again to FIG. 8, the uniformly mixed fiber reinforced polypropylene composite melt comprising polypropylene based polymer 510, inorganic filler 512, and organic fiber 514 is metered by the extruder screws to a strand die 528 for forming one or more continuous strands 540 of fiber reinforced polypropylene composite melt. The one or more continuous strands 540 are then passed into water bath 542 for cooling them below the melting point of the fiber reinforced polypropylene composite melt to form a solid fiber reinforced polypropylene composite strands 544. The water bath 542 is typically cooled and controlled to a constant temperature much below the melting point of the polypropylene based polymer. The solid fiber reinforced polypropylene composite strands 544 are then passed into a pelletizer or pelletizing unit 546 to cut them into fiber reinforced polypropylene composite resin 548 measuring from about ¼ inch to about 1 inch in length. The fiber reinforced polypropylene composite resin 548 may then be accumulated in containers 550 or alternatively conveyed to silos for storage and eventually conveyed to injection molding line 600, for molding into the fiber reinforced polypropylene composite door core modules of the present invention.

The present invention and the advantages thereto are further illustrated by means of the following examples, without limiting the scope thereof.

Test Methods

Fiber reinforced polypropylene compositions described herein were injection molded at 2300 psi pressure, 401° C. at all heating zones as well as the nozzle, with a mold temperature of 60° C.

Flexural modulus data was generated for injected molded samples produced from the fiber reinforced polypropylene compositions described herein using the ISO 178 standard procedure.

Instrumented impact test data was generated for injected mold samples produced from the fiber reinforced polypropylene compositions described herein using ASTM D3763. Ductility during instrumented impact testing (test conditions of 15 mph, −29° C., 25 lbs) is defined as no splintering of the sample.

### EXAMPLES

PP3505G is a propylene homopolymer commercially available from ExxonMobil Chemical Company of Baytown, Tex. The MFR (2.16 kg, 230° C.) of PP3505G was measured according to ASTM D1238 to be 400 g/10 min.

PP7805 is an 80 MFR propylene impact copolymer commercially available from ExxonMobil Chemical Company of Baytown, Tex.

PP8114 is a 22 MFR propylene impact copolymer containing ethylene-propylene rubber and a plastomer, and is commercially available from ExxonMobil Chemical Company of Baytown, Tex.

PP8224 is a 25 MFR propylene impact copolymer containing ethylene-propylene rubber and a plastomer, and is commercially available from ExxonMobil Chemical Company of Baytown, Tex.

PO1020 is 430 MFR maleic anhydride functionalized polypropylene homopolymer containing 0.5-1.0 weight percent maleic anhydride.

Cimpact CB7 is a surface modified talc, V3837 is a high aspect ratio talc, and Jetfine 700 C is a high surface area talc, all available from Luzenac America Inc. of Englewood, Colo.

### Illustrative Examples 1-8

Varying amounts of PP3505G and 0.25″ long polyester fibers obtained from Invista Corporation were mixed in a Haake single screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact under standard automotive conditions for interior parts (25 lbs, at 15 MPH, at −29° C.). The total energy absorbed and impact results are given in Table 1.

TABLE 1

| | wt % | | Total Energy | Instrumented Impact |
|---|---|---|---|---|
| Example # | PP3505G | wt % Fiber | (ft-lbf) | Test Results |
| 1 | 65 | 35 | 8.6 ± 1.1 | ductile* |
| 2 | 70 | 30 | 9.3 ± 0.6 | ductile* |
| 3 | 75 | 25 | 6.2 ± 1.2 | ductile* |
| 4 | 80 | 20 | 5.1 ± 1.2 | ductile* |
| 5 | 85 | 15 | 3.0 ± 0.3 | ductile* |
| 6 | 90 | 10 | 2.1 ± 0.2 | ductile* |
| 7 | 95 | 5 | 0.4 ± 0.1 | brittle** |
| 8 | 100 | 0 | <0.1 | brittle*** |

*Examples 1-6: samples did not shatter or split as a result of impact, with no pieces coming off of the specimen.
**Example 7: pieces broke off of the sample as a result of the impact
***Example 8: samples completely shattered as a result of impact.

### Illustrative Examples 9-14

In Examples 9-11, 35 wt % PP7805, 20 wt % Cimpact CB7 talc, and 45 wt % 0.25″ long polyester fibers obtained from Invista Corporation, were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact. The total energy absorbed and impact results are given in Table 2.

In Examples 12-14, PP8114 was extruded and injection molded under the same conditions as those for Examples 9-11. The total energy absorbed and impact results are given in Table 2.

TABLE 2

| | | | |
|---|---|---|---|
| | | Total | Instrumented |
| | Impact Conditions/Applied | Energy | Impact Test |
| Example # | Energy | (ft-lbf) | Results |

35 wt % PP7805 (70 MFR), 20 wt % talc, 45 wt % fiber

| | | | |
|---|---|---|---|
| 9 | −29° C., 15 MPH, 25 lbs/192 ft-lbf | 16.5 | ductile* |
| 10 | −29° C., 28 MPH, 25 lbs/653 ft-lbf | 14.2 | ductile* |
| 11 | −29° C., 21 MPH, 58 lbs/780 ft-lbf | 15.6 | ductile* |

100 wt % PP8114 (22 MFR)

| | | | |
|---|---|---|---|
| 12 | −29° C., 15 MPH, 25 lbs/192 ft-lbf | 32.2 | ductile* |
| 13 | −29° C., 28 MPH, 25 lbs/653 ft-lbf | 2.0 | brittle** |
| 14 | −29° C., 21 MPH, 58 lbs/780 ft-lbf | 1.7 | brittle** |

*Examples 9-12: samples did not shatter or split as a result of impact, with no pieces coming off of the specimen.
**Examples 13-14: samples shattered as a result of impact.

### Illustrative Examples 15-16

A Leistritz ZSE27 HP-60D 27 mm twin screw extruder with a length to diameter ratio of 40:1 was fitted with six pairs of kneading elements 12″ from the die exit to form a kneading block. The die was ¼″ in diameter. Strands of continuous 27,300 denier PET fibers were fed directly from spools into the hopper of the extruder, along with PP7805 and talc. The kneading elements in the kneading block in the extruder broke up the fiber in situ. The extruder speed was 400 revolutions per minute, and the temperatures across the extruder were held at 190° C. Injection molding was done under conditions similar to those described for Examples 1-14. The mechanical and physical properties of the sample were measured and are compared in Table 3 with the mechanical and physical properties of PP8224.

The instrumented impact test showed that in both examples there was no evidence of splitting or shattering, with no pieces coming off the specimen. In the notched charpy test, the PET fiber-reinforced PP7805 specimen was only partially broken, and the PP8224 specimen broke completely.

TABLE 3

| | Example 15 | |
|---|---|---|
| Test | PET fiber-reinforced | Example 16 |
| (Method) | PP7805 with talc | PP8224 |
| Flexural Modulus, Chord | 525, 190 psi | 159, 645 psi |
| (ISO 178) | | |
| Instrumented Impact at −30° C. | 6.8 J | 27.5 J |
| Energy to maximum load | | |
| 100 lbs at 5 MPH | | |
| (ASTM D3763) | | |
| Notched Charpy Impact at | 52.4 kJ/m² | 5.0 kJ/m² |
| −40° C. | | |
| (ISO 179/1eA) | | |
| Heat Deflection Temperature | 116.5° C. | 97.6° C. |
| at 0.45 Mpa, edgewise | | |
| (ISO 75) | | |
| Coefficient of Linear Thermal | 2.2/12.8 | 10.0/18.6 |
| Expansion, −30° C. to 100° C., | (E-5/° C.) | (E-5/° C.) |
| Flow/Crossflow | | |
| (ASTM E831) | | |

### Illustrative Examples 17-18

In Examples 17-18, 30 wt % of either PP3505G or PP8224, 15 wt % 0.25″ long polyester fibers obtained from Invista Corporation, and 45 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus.

The flexural modulus results are given in Table 4.

TABLE 4

| | | | Instrumented Impact |
|---|---|---|---|
| | | | at −30° C. |
| | | | Energy to maximum |
| | | Flexural Modulus, | load |
| | | Chord, psi | 25 lbs at 15 MPH |
| Example | Polypropylene, | (ISO 178) | (ASTM D3763), ft-lb |
| 17 | PP8224 | 433840 | 2 |
| 18 | PP3505 | 622195 | 2.9 |

The rubber toughened PP8114 matrix with PET fibers and talc displayed lower impact values than the PP3505 homopolymer. This result is surprising, because the rubber toughened matrix alone is far tougher than the low molecular weight PP3505 homopolymer alone at all temperatures under any conditions of impact. In both examples above, the materials displayed no splintering.

### Illustrative Examples 19-24

In Examples 19-24, 25-75 wt % PP3505G, 15 wt % 0.25″ long polyester fibers obtained from Invista Corporation, and 10-60 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 5.

TABLE 5

| | | Flexural Modulus, |
|---|---|---|
| Example | Talc Composition, | Chord, psi (ISO 178) |
| 19 | 10% | 273024 |
| 20 | 20% | 413471 |
| 21 | 30% | 583963 |
| 22 | 40% | 715005 |
| 23 | 50% | 1024394 |
| 24 | 60% | 1117249 |

It is important to note that in examples 19-24, the samples displayed no splintering in drop weight testing at an −29° C., 15 miles per hour at 25 pounds.

### Illustrative Examples 25-26

Two materials, one containing 10% ¼ inch polyester fibers, 35% PP3505 polypropylene and 60% V3837 talc (example 25), the other containing 10% ¼ inch polyester fibers, 25% PP3505 polypropylene homopolymer (example 26), 10% PO1020 modified polypropylene were molded in a Haake twin screw extruder at 175° C. They were injection molded into standard ASTM A370 V2 inch wide sheet type tensile specimens. The specimens were tested in tension, with a ratio of minimum to maximum load of 0.1, at flexural stresses of 70 and 80% of the maximum stress.

TABLE 6

| Percentage of | | |
|---|---|---|
| Maximum Stress to | Example 25, | Example 26, |
| Yield Point | Cycles to failure | Cycles to failure |
| 70 | 327 | 9848 |
| 80 | 30 | 63 |

The addition of the modified polypropylene is shown to increase the fatigue life of these materials.

### Illustrative Examples 27-29

A Leistritz 27 mm co-rotating twin screw extruder with a ratio of length to diameter of 40:1 was used in these experiments. The process configuration utilized was as depicted in FIG. 8. The screw configuration used is depicted in FIG. 10, and includes an arrangement of conveying and kneading elements. Talc, polypropylene and PET fiber were all fed into the extruder feed hopper located approximately two diameters from the beginning of the extruder screws (19 in the FIG. 10). The PET fiber was fed into the extruder hopper by continuously feeding from multiple spools a fiber tow of 3100 filaments with each filament having a denier of approximately 7.1. Each filament was 27 microns in diameter, with a specific gravity of 1.38.

The twin screw extruder ran at 603 rotations per minute. Using two gravimetric feeders, PP7805 polypropylene was fed into the extruder hopper at a rate of 20 pounds per hour, while CB 7 talc was fed into the extruder hopper at a rate of 15 pounds per hour. The PET fiber was fed into the extruder at 12 pounds per hour, which was dictated by the screw speed and tow thickness. The extruder temperature profile for the ten zones 144° C. for zones 1-3, 133° C. for zone 4, 154° C. for zone 5, 135° C. for zone 6, 123° C. for zones 7-9, and 134° C. for zone 10. The strand die diameter at the extruder exit was ¼ inch.

The extrudate was quenched in an 8 foot long water trough and pelletized to ½ inch length to form PET/PP composite pellets. The extrudate displayed uniform diameter and could easily be pulled through the quenching bath with no breaks in the water bath or during instrumented impact testing. The composition of the PET/PP composite pellets produced was 42.5 wt % PP, 25.5 wt % PET, and 32 wt % talc.

The PET/PP composite resin produced was injection molded and displayed the following properties:

TABLE 7

| | Example 27 |
|---|---|
| Specific Gravity | 1.3 |
| Tensile Modulus, Chord @ 23° C. | 541865 psi |
| Tensile Modulus, Chord @ 85° C. | 257810 psi |
| Flexural Modulus, Chord @ 23° C. | 505035 psi |
| Flexural Modulus, Chord @ 85° C. | 228375 psi |
| HDT @ 0.45 MPA | 116.1° C. |
| HDT @ 1.80 MPA | 76.6° C. |
| Instrumented impact @ 23° C. | 11.8 J D** |
| Instrumented impact @ −30° C. | 12.9 J D** |

**Ductile failure with radial cracks

In example 28, the same materials, composition, and process set-up were utilized, except that extruder temperatures were increased to 175° C. for all extruder barrel zones. This material showed complete breaks in the instrumented impact test both at 23° C. and −30° C. Hence, at a barrel temperature profile of 175° C., the mechanical properties of the PET fiber were negatively impacted during extrusion compounding such that the PET/PP composite resin had poor instrumented impact test properties.

In example 29, the fiber was fed into a hopper placed 14 diameters down the extruder (527 in the FIG. 10). In this case, the extrudate produced was irregular in diameter and broke an average once every minute as it was pulled through the quenching water bath. When the PET fiber tow is continuously fed downstream of the extruder hopper, the dispersion of the PET in the PP matrix was negatively impacted such that a uniform extrudate could not be produced, resulting in the irregular diameter and extrudate breaking.

### Illustrative Example 30

An extruder with the same size and screw design as examples 27-29 was used. All zones of the extruder were initially heated to 180° C. PP 3505 dry mixed with Jetfine 700 C and PO 1020 was then fed at 50 pounds per hour using a gravimetric feeder into the extruder hopper located approximately two diameters from the beginning of the extruder screws. Polyester fiber with a denier of 7.1 and a thickness of 3100 filaments was fed through the same hopper. The screw speed of the extruder was then set to 596 revolutions per minute, resulting in a feed rate of 12.1 pounds of fiber per hour. After a uniform extrudate was attained, all temperature zones were lowered to 120° C., and the extrudate was pelletized after steady state temperatures were reached. The final composition of the blend was 48% PP 3505, 29.1% Jetfine 700 C, 8.6% PO 1020 and 14.3% polyester fiber.

The PP composite resin produced while all temperature zones of the extruder were set to 120° C. was injection molded and displayed the following properties:

TABLE 8

| | Example 30 |
|---|---|
| Flexural Modulus, Chord @ 23° C. | 467,932 psi |
| Instrumented impact @ 23° C. | 8.0 J D** |
| Instrumented impact @ −30° C. | 10.4 J D** |

**Ductile failure with radial cracks

In another embodiment, this invention relates to:

1. A fiber reinforced composite door core module, said door core module comprising a module plate molded from a composition comprising at least 30 wt % polypropylene based resin, from 10 to 60 wt % organic fiber, from 0 to 40 wt % inorganic filler, and optionally lubricant (typically present at from 0 to 0.1 wt %), based on the total weight of the composition, said module plate having at least a first side and a second side.

2. The fiber reinforced composite door core module of paragraph 1, wherein said polypropylene based resin is selected from the group consisting of polypropylene homopolymers, propylene-ethylene random copolymers, propylene-α-olefin random copolymers, propylene impact copolymers, and combinations thereof.

3. The fiber reinforced composite door core module of paragraph 1 or 2, wherein said polypropylene based resin is polypropylene homopolymer with a melt flow rate of from about 20 to about 1500 g/10 minutes.

4. The fiber reinforced composite door core module of any of paragraphs 1 to 3, wherein said polypropylene based resin further comprises from about 0.1 wt % to less than about 10 wt % of a polypropylene based polymer modified with a grafting agent, wherein said grafting agent is selected from the group consisting of acrylic acid, methacrylic acid, maleic acid, itaconic acid, fumaric acid or esters thereof, maleic anhydride, itaconic anhydride, and combinations thereof.

5. The fiber reinforced composite door core module of any of paragraphs 1 to 4, wherein said lubricant is selected from the group consisting of silicon oil, silicon gum, fatty amide, paraffin oil, paraffin wax, and ester oil.

6. The fiber reinforced composite door core module of any of paragraphs 1 to 5, wherein said organic fiber is selected from the group consisting of polyalkylene terephthalates, polyalkylene naphthalates, polyamides, polyolefins, polyacrylonitrile, and combinations thereof.

7. The fiber reinforced composite door core module of any of paragraphs 1 to 6, wherein said inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

8. The fiber reinforced composite door core module of any of paragraphs 1 to 7, wherein said door core module has a flexural modulus of at least 300,000 psi and exhibits ductility during instrumented impact testing

9. The fiber reinforced composite door core module of any of paragraphs 1 to 8, further comprising a window winder mechanism installed on either said first side or said second side of said module plate.

10. The fiber reinforced composite door core module of any of paragraphs 1 to 9, further comprising a pair of lateral guide rails for receiving a window pane.

11. The fiber reinforced composite door core module of any of paragraphs 1 to 10, wherein a door frame is integrally molded to said first side of said module plate.

12. The fiber reinforced composite door core module of any of paragraphs 1 to 11, wherein an interior trim panel is integrally molded to said second side of said module plate.

13. The fiber reinforced composite door core module of any of paragraphs 1 to 11, wherein an outer body shell is integrally molded to said first side of said module plate.

14. The fiber reinforced composite door core module of any of paragraphs 1 to 13, further comprising a pair of reinforcing tubes.

15. A process for producing a fiber reinforced composite door core module, the door core module having a module plate having a first side and a second side, the process comprising the step of injection molding a composition to form the door core module, wherein the composition comprises at least 30 wt % polypropylene, from 10 to 60 wt % organic fiber, from 0 to 40 wt % inorganic filler, and optionally lubricant (typically present at from 0 to 0.1 wt %), based on the total weight of the composition.

16. The process of paragraph 15, wherein the door core module has a flexural modulus of at least 300,000 psi and exhibits ductility during instrumented impact testing 17. The process of paragraph 15 or 16, further comprising the step of integrally molding a door frame to the first side of the module plate of the door core module.

18. The process of paragraph 15, 16 or 17, further comprising the step of integrally molding an interior trim panel to the second side of the module plate of the door core module.

19. The process of paragraph 15, 16, 17 or 18, further comprising the following steps:
(a) feeding into a twin screw extruder hopper at least about 25 wt % of a polypropylene based resin with a melt flow rate of from about 20 to about 1500 g/10 minutes;
(b) continuously feeding by unwinding from one or more spools into the twin screw extruder hopper from about 5 wt % to about 40 wt % of an organic fiber;
(c) feeding into a twin screw extruder from about 10 wt % to about 60 wt % of an inorganic filler;
(d) extruding the polypropylene based resin, the organic fiber, and the inorganic filler through the twin screw extruder to form a fiber reinforced polypropylene composite melt; and
(e) cooling the fiber reinforced polypropylene composite melt to form a solid fiber reinforced polypropylene composite;
wherein steps (a)-(e) are conducted prior to said injection molding step.

20. The process of paragraph 19, wherein said step of feeding the inorganic filler into the twin screw extruder further comprises feeding the inorganic filler into the twin screw extruder hopper via a gravimetric feed system or feeding the inorganic filler into the twin screw extruder at a downstream injection port via a gravimetric feed system.

All patents, test procedures, and other documents cited herein, including priority documents, are fully incorporated by reference to the extent such disclosure is not inconsistent with this invention and for all jurisdictions in which such incorporation is permitted.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the invention, including all features which would be treated as equivalents thereof by those skilled in the art to which the invention pertains.

When numerical lower limits and numerical upper limits are listed herein, ranges from any lower limit to any upper limit are contemplated.

We claim:

1. A fiber reinforced composite door core module, said door core module comprising a module plate molded from a composition comprising at least 30 wt % polypropylene based resin, from 10 to 60 wt % organic fiber, and from 0 to 40 wt % inorganic filler, based on the total weight of the composition, said module plate having at least a first side and a second side.

2. The fiber reinforced composite door core module of claim 1, wherein said polypropylene based resin is selected from the group consisting of polypropylene homopolymers, propylene-ethylene random copolymers, propylene-α-olefin random copolymers, propylene impact copolymers, and combinations thereof.

3. The fiber reinforced composite door core module of claim 2, wherein said polypropylene based resin is polypropylene homopolymer with a melt flow rate of from about 20 to about 1500 g/10 minutes.

4. The fiber reinforced composite door core module of claim 1, wherein said polypropylene based resin further comprises from about 0.1 wt % to less than about 10 wt % of a polypropylene based polymer modified with a grafting agent, wherein said grafting agent is selected from the group consisting of acrylic acid, methacrylic acid, maleic acid, itaconic acid, fumaric acid or esters thereof, maleic anhydride, itaconic anhydride, and combinations thereof.

5. The fiber reinforced composite door core module of claim of claim 1, wherein composite comprises optionally from 0 to 0.1 wt % of lubricant selected from the group consisting of silicon oil, silicon gum, fatty amide, paraffin oil, paraffin wax, and ester oil.

6. The fiber reinforced composite door core module of claim 1, wherein said organic fiber is selected from the group consisting of polyalkylene terephthalates, polyalkylene naphthalates, polyamides, polyolefins, polyacrylonitrile, and combinations thereof.

7. The fiber reinforced composite door core module of claim 6, wherein said organic fiber is polyethylene terephthalate.

8. The fiber reinforced composite door core module of claim 1, wherein said inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

9. The fiber reinforced composite door core module of claim 8, wherein said inorganic filler is talc or wollastonite.

10. The fiber reinforced composite door core module of claim 1, wherein said door core module has a flexural modulus of at least 300,000 psi and exhibits ductility during instrumented impact testing

11. The fiber reinforced composite door core module of claim 1, wherein said door core module has a flexural modulus of at least 400,000 psi, and exhibits ductility during instrumented impact testing,

12. The fiber reinforced composite door core module of claim 1, further comprising a window winder mechanism installed on either said first side or said second side of said module plate.

13. The fiber reinforced composite door core module of claim 12, further comprising a pair of lateral guide rails for receiving a window pane.

14. The fiber reinforced composite door core module of claim 1, wherein a door frame is integrally molded to said first side of said module plate.

15. The fiber reinforced composite door core module of claim 14, wherein an interior trim panel is integrally molded to said second side of said module plate.

16. The fiber reinforced composite door core module of claim 1, wherein an interior trim panel is integrally molded to said second side of said module plate.

17. The fiber reinforced composite door core module of claim 1, wherein an outer body shell is integrally molded to said first side of said module plate.

18. The fiber reinforced composite door core module of claim 1, further comprising a pair of reinforcing tubes.

19. A process for producing a fiber reinforced composite door core module, the door core module having a module plate having a first side and a second side, the process comprising the step of injection molding a composition to form the door core module, wherein the composition comprises at least 30 wt % polypropylene, from 10 to 60 wt % organic fiber, and from 0 to 40 wt % inorganic filler, based on the total weight of the composition.

20. The process of claim 19, wherein the door core module has a flexural modulus of at least 300,000 psi and exhibits ductility during instrumented impact testing

21. The process of claim 19, wherein the composition is formed by a step comprising extrusion compounding to form an extrudate.

22. The process of claim 21, wherein the organic fiber is cut prior to the extrusion compounding step.

23. The process of claim 21, wherein during the extrusion compounding step, the organic fiber is a continuous fiber and is fed directly from one or more spools into an extruder hopper.

24. The process of claim 19, further comprising the step of installing a window winder mechanism on a first side or second side of a module plate of the door core module.

25. The process of claim 24, further comprising the step of installing a pair of lateral guide rails for receiving a window pane.

26. The process of claim 19, further comprising the step of integrally molding a door frame to the first side of the module plate of the door core module.

27. The process of claim 26, further comprising the step of integrally molding an interior trim panel to the second side of the module plate of the door core module.

28. The process of claim 19, further comprising the step of integrally molding an interior trim panel to the second side of a module plate of the door core module.

29. The process of claim 28, further comprising the step of installing a pair of reinforcing tubes on the door core module.

30. The process of claim 19, further comprising the step of installing a pair of reinforcing tubes on the door core module.

31. A process for making a fiber reinforced polypropylene composite door core module, comprising the following steps:
(a) feeding into a twin screw extruder hopper at least about 25 wt % of a polypropylene based resin with a melt flow rate of from about 20 to about 1500 g/10 minutes;
(b) continuously feeding by unwinding from one or more spools into the twin screw extruder hopper from about 5 wt % to about 40 wt % of an organic fiber;
(c) feeding into a twin screw extruder from about 10 wt % to about 60 wt % of an inorganic filler;
(d) extruding the polypropylene based resin, the organic fiber, and the inorganic filler through the twin screw extruder to form a fiber reinforced polypropylene composite melt;
(e) cooling the fiber reinforced polypropylene composite melt to form a solid fiber reinforced polypropylene composite; and
(f) injection molding the fiber reinforced polypropylene composite to form the door core module, the door core module having a module plate having a first side and a second side.

32. The process of claim 31, wherein the fiber reinforced polypropylene composite door core module has a flexural modulus of at least about 300,000 psi and exhibits ductility during instrumented impact testing.

33. The process of claim 31, wherein the polypropylene based resin is selected from the group consisting of polypropylene homopolymers, propylene-ethylene random copolymers, propylene-α-olefin random copolymers, propylene impact copolymers, and combinations thereof.

34. The process of claim 31, wherein the organic fiber is selected from the group consisting of polyalkylene terephthalates, polyalkylene naphthalates, polyamides, polyolefins, polyacrylonitrile, and combinations thereof.

35. The process of claim 34, wherein the organic fiber is polyethylene terephthalate.

36. The process of claim 31, wherein the inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

37. The process of claim 36, wherein the inorganic filler is talc or wollastonite.

38. The process of claim 31, wherein said step of feeding the inorganic filler into the twin screw extruder further comprises feeding the inorganic filler into the twin screw extruder hopper via a gravimetric feed system or feeding the inorganic filler into the twin screw extruder at a downstream injection port via a gravimetric feed system.

39. The process of claim 31, wherein said step of cooling the fiber reinforced polypropylene composite melt to form a solid fiber reinforced polypropylene composite is by continuously passing strands of the fiber reinforced polypropylene composite melt through a cooled water bath.

40. The process of claim 31, further comprising the step of:
(g) integrally molding an interior trim panel to the second side of a module plate of the door core module.
